(19) United States
(12) Patent Application Publication
(10) Pub. No.: US 2026/0209453 A1
(43) Pub. Date: Jul. 23, 2026

(54) TRANSPARENT POLYIMIDE FILM

(71) Applicant: TAIMIDE TECHNOLOGY INCORPORATION, Hsinchu Hsien (TW)

(72) Inventors: YUNG-CHU CHUANG, Hsinchu Hsien (TW); TING-TING TSAI, Hsinchu Hsien (TW)

(73) Assignee: TAIMIDE TECHNOLOGY INCORPORATION, Hsinchu Hsien (TW)

(21) Appl. No.: 19/399,675

(22) Filed: Nov. 25, 2025

(30) Foreign Application Priority Data
Jan. 23, 2025 (TW) 114103110

(51) Int. Cl. C08J 5/18; C08K 5/00

(52) U.S. Cl. CPC C08J 5/18; C08K 5/0041; C08K 5/005; C08J 2479/08

(57) ABSTRACT

The present disclosure relates to a transparent polyimide film obtained by polymerizing a diamine and a dianhydride to form a polyamic acid, followed by chemical cyclization, where the diamine includes: 4,4′-diamino-2,2′-dimethylbiphenyl (m-TB); and one or a combination of 3,3′-diaminodiphenyl sulfone (33DDS), 4,4′-diaminodiphenyl sulfone (44DDS), bis[4-(3-aminophenoxy)phenyl]sulfone (m-BAPS), or bis[4-(4-aminophenoxy)phenyl]sulfone (p-BAPS); where based on the total mole number of the diamine, the 4,4′-diamino-2,2′-dimethylbiphenyl (m-TB) accounts for 40-60 mol %; and the dianhydride includes: 1,2,3,4-cyclobutanetetracarboxylic dianhydride (CBDA); and one or a combination of 3,3′,4,4′-biphenyltetracarboxylic dianhydride (BPDA) or 4,4′-(4,4′-isopropylidenediphenoxy)diphthalic anhydride (BPADA); where based on the total mole number of the dianhydride, the 1,2,3,4-cyclobutanetetracarboxylic dianhydride (CBDA) accounts for 65-85 mol %; and where the transparent polyimide film has a Young's modulus of 4 GPa or more and a yellow index (YI) value of less than 5.

### CROSS-REFERENCE TO RELATED APPLICATION

This non-provisional application claims priority under 35 U.S.C. § 119(a) on Patent Application No(s). 114103110 filed in Taiwan, R.O.C. on Jan. 23, 2025, the entire contents of which are hereby incorporated by reference.

### BACKGROUND OF THE INVENTION

### 1. Field of the Invention

The present disclosure relates to a transparent polyimide film, in particular to a fluorine atom-free transparent polyimide film, which has a Young's modulus of 4 GPa or more and a yellow index (YI) of less than 5.

### 2. Description of the Related Art

Display devices are currently widely applied in mobile phones and tablet computers. In the past, glass was used as the cover plate for displays. However, with the development of flexible displays, glass cover plates cannot meet the flexural characteristics. Therefore, polyimide optical films have been proposed to be used as one of the materials to replace glass.

Compared with other polymer films, polyimide films have excellent mechanical characteristics, heat resistance, dimensional stability, and electrical characteristics. At present, they have been widely used in electronic materials such as flexible printed circuit boards, aerospace, and automobiles. However, for display applications, they need to have excellent optical characteristics. Since the charge transfer complex (CTC) in the polyimide resin forms a dark brown color, the introduction of fluorine-containing groups can effectively solve the coloration issue of the polyimide film, which is also a commonly used technical means at present.

In recent years, with the rise of environmental awareness, per- and polyfluoroalkyl substances (PFAS) have become a hot topic in the fields of global environment and health. This type of man-made chemical substance is widely applied in daily life due to its excellent water, oil, and stain resistance. However, it is precisely this universality, combined with their environmental persistence, that makes PFAS a tricky global problem. However, the fluorine-containing monomers used in transparent polyimide may release PFAS or form PFAS in the degradation process. Some studies are exploring fluorine-free alternative materials or improved synthesis methods, and the industry is also actively seeking substitutes for PFAS.

### BRIEF SUMMARY OF THE INVENTION

The present disclosure proposes a transparent polyimide film, in particular to a fluorine atom-free transparent polyimide film, which has a Young's modulus of 4 GPa or more and a yellow index (YI) of less than 5.

The present disclosure relates to a transparent polyimide film obtained by polymerizing a diamine and a dianhydride to form a polyamic acid, followed by chemical cyclization, where the diamine includes: 4,4′-diamino-2,2′-dimethylbiphenyl (m-TB); and one or a combination of 3,3′-diaminodiphenyl sulfone (33DDS), 4,4′-diaminodiphenyl sulfone (44DDS), bis[4-(3-aminophenoxy)phenyl]sulfone (m-BAPS), or bis[4-(4-aminophenoxy)phenyl]sulfone (p-BAPS); where based on the total mole number of the diamine, the 4,4′-diamino-2,2′-dimethylbiphenyl (m-TB) accounts for 40-60 mol %; and the dianhydride includes: 1,2,3,4-cyclobutanetetracarboxylic dianhydride (CBDA); and one or a combination of 3,3′,4,4′-biphenyltetracarboxylic dianhydride (BPDA) or 4,4′-(4,4′-isopropylidenediphenoxy)diphthalic anhydride (BPADA); where based on the total mole number of the dianhydride, the 1,2,3,4-cyclobutanetetracarboxylic dianhydride (CBDA) accounts for 65-85 mol %; and where the transparent polyimide film has a Young's modulus of 4 GPa or more and a yellow index (YI) of less than 5.

In a preferred embodiment of the present disclosure, the polyamic acid further includes a copolymer segment composed of the 4,4′-diamino-2,2′-dimethylbiphenyl (m-TB) and the 1,2,3,4-cyclobutanetetracarboxylic dianhydride (CBDA).

In a preferred embodiment of the present disclosure, a molar ratio of the 4,4′-diamino-2,2′-dimethylbiphenyl (m-TB) to the 1,2,3,4-cyclobutanetetracarboxylic dianhydride (CBDA) in the copolymer segment may be 0.5, 0.55, 0.6, 0.65, 0.7, 0.75, 0.8, 0.85, 0.9, or 0.95, and preferably greater than 0.6.

In a preferred embodiment of the present disclosure, a molar ratio of the 4,4′-diamino-2,2′-dimethylbiphenyl (m-TB) to the 1,2,3,4-cyclobutanetetracarboxylic dianhydride (CBDA) in the copolymer segment is more preferably 0.7, 0.75, 0.8, 0.85, 0.9, or 0.95.

In a preferred embodiment of the present disclosure, the transparent polyimide film has a Young's modulus of 4.5 GPa or more, and more preferably 5 GPa or more.

In a preferred embodiment of the present disclosure, the transparent polyimide film may include at least one color toner, where based on a total weight of the transparent polyimide film, the color toner accounts for 5-40 ppm, and the transparent polyimide film has a yellow index (YI) of less than 4.

In a preferred embodiment of the present disclosure, the transparent polyimide film may include at least one ultraviolet absorber.

In a preferred embodiment of the present disclosure, the ultraviolet absorber may be benzophenone, benzotriazole, triazine, oxanilide or cyanoacrylate ultraviolet absorbers.

In a preferred embodiment of the present disclosure, based on the total weight of the transparent polyimide film, the ultraviolet absorber accounts for 1-15 wt %.

In a preferred embodiment of the present disclosure, a thickness of the transparent polyimide film may be less than 75 μm.

In a preferred embodiment of the present disclosure, the transparent polyimide film has a transmittance of greater than 87%.

### DETAILED DESCRIPTION OF THE INVENTION

The present disclosure relates to a transparent polyimide film obtained by polymerizing a diamine and a dianhydride to form a polyamic acid followed by chemical cyclization. The diamine includes 4,4′-diamino-2,2′-dimethylbiphenyl (m-TB), and one or a combination of 3,3′-diaminodiphenyl sulfone (33DDS), 4,4′-diaminodiphenyl sulfone (44DDS), bis[4-(3-aminophenoxy)phenyl]sulfone (m-BAPS) or bis[4-(4-aminophenoxy)phenyl]sulfone (p-BAPS). The 4,4′-diamino-2,2′-dimethylbiphenyl (m-TB) accounts for 40-60 mol % of the total mole number of the diamine. The dianhydride includes 1,2,3,4-cyclobutanetetracarboxylic dianhydride (CBDA), and one or a combination of 3,3′,4,4′-biphenyltetracarboxylic dianhydride (BPDA) or 4,4′-(4,4′-isopropylidenediphenoxy)diphthalic anhydride (BPADA). The 1,2,3,4-cyclobutanetetracarboxylic dianhydride (CBDA) accounts for 65-85 mol % of the total mole number of the dianhydride. In addition, the transparent polyimide film has a Young's modulus of 4 GPa or more and a yellow index (YI) of less than 5.

### Preparation of Polyamic Acid

A transparent polyimide film is obtained by polymerizing a diamine and a dianhydride in an organic solvent to form a polyamic acid, followed by chemical cyclization.

The diamine includes: 4,4′-diamino-2,2′-dimethylbiphenyl (m-TB); and one or a combination of 3,3′-diaminodiphenyl sulfone (33DDS), 4,4′-diaminodiphenyl sulfone (44DDS), bis[4-(3-aminophenoxy)phenyl]sulfone (m-BAPS), or bis[4-(4-aminophenoxy)phenyl]sulfone (p-BAPS).

The dianhydride includes 1,2,3,4-cyclobutanetetracarboxylic dianhydride (CBDA); and one or a combination of 3,3′,4,4′-biphenyltetracarboxylic dianhydride (BPDA), 4,4′-(4,4′-isopropylidenediphenoxy)diphthalic anhydride (BPADA), or 1,2,4,5-cyclohexanetetracarboxylic dianhydride (H-PMDA).

Solvent: For preparation of the polyamic acid, dimethylacetamide (DMAc), N-methylpyrrolidone (NMP), N-ethyl-2-pyrrolidone (NEP), y-butyrolactone (GBL), or N,N-dimethylformamide (DMF) may be used as a solvent. In a preferred embodiment of the present disclosure, dimethylacetamide is used as the solvent.

### Preparation of Transparent Polyimide Film

The polyamic acid, a catalyst, and a dehydrating agent are stirred uniformly for chemical cyclization. The dehydrating agent may be acetic anhydride or benzoic anhydride, and in a preferred embodiment of the present disclosure, acetic anhydride is selected as the dehydrating agent. The catalyst may be pyridine, 3-picoline, 2-picoline, 4-picoline, isoquinoline, quinoline, or triethylamine, with pyridine, 3-picoline, 2-picoline, and 4-picoline as preferred choices, and in a preferred embodiment of the present disclosure, 3-picoline is selected as the catalyst.

The above catalyst and dehydrating agent may be used alone, or they may be mixed with the solvent for dilution before being added to the mixture.

After uniformly stirring the mixed solution of polyamic acid with the dehydrating agent and the catalyst incorporated, a centrifugal defoaming machine is used for defoaming. The defoamed solution is poured onto a glass substrate and coated using a doctor blade with a 900 m gap. The coated sample is placed in an oven at 80° C. for baking for 40 minutes, heated to 170° C. for baking for 10 minutes, and then heated to 260° C. for baking for 10 minutes as the final treatment. After baking is completed, the glass is placed in water, and the film on the glass substrate is peeled off to obtain the transparent polyimide film.

### <Detection Method>

The mechanical properties and optical properties of the transparent polyimide films obtained in the following examples were measured using the following methods.

Yellow index (YI): it was measured in accordance with ASTM E313 standard using an instrument model NE-4000 manufactured by Nippon Denshoku.

Young's modulus: it was measured in accordance with ASTM D882 standard using a Hounsfield H10K-S tensile machine.

### Example 1

### Production of Polyamic Acid Solution

20.117 grams of 4,4′-diamino-2,2′-dimethylbiphenyl (m-TB) was added to 440 grams of N,N-dimethylacetamide (DMAc). After complete dissolution, 35.292 grams of 4,4′-diaminodiphenyl sulfone (44DDS) was added. Upon its complete dissolution, 30.197 grams of 1,2,3,4-cyclobutanetetracarboxylic dianhydride (CBDA) was added. After stirring for a certain period, 24.394 grams of 3,3′,4,4′-biphenyltetracarboxylic dianhydride (BPDA) was finally added, and the temperature of the solution was maintained at 25° C. A polyamic acid solution with a solid content of 20% was obtained eventually.

### Preparation of Transparent Polyimide Film

49 grams of the polyamic acid solution and 21 grams of N,N-dimethylacetamide (DMAc) were uniformly stirred and mixed. After uniform stirring, acetic anhydride (AA) and N,N-dimethylacetamide (DMAc) were diluted at a weight ratio of 5:1, and 3-picoline (AP) and N,N-dimethylacetamide (DMAc) were diluted at a weight ratio of 1:1. Then 4.16 milliliters of the diluted AA solution and 1.66 milliliters of the diluted AP solution were added, respectively. After uniform stirring, defoaming was performed using a centrifugal defoaming machine. The defoamed solution was poured onto a glass substrate and coated using a doctor blade with a 900 μm gap. The coated sample was placed in an oven at 80° C. for baking for 20 minutes, then heated to 170° C. at a rate of 6° C./min for baking for 10 minutes, and further heated to 260° C. at a rate of 6.0° C./min for baking for 10 minutes as the final treatment.

The glass substrate was immersed in water, and the transparent polyimide film was peeled off from the glass substrate. The thickness of the transparent polyimide film was 50 μm.

### Example 2

### Production of Polyamic Acid Solution

20.117 grams of 4,4′-diamino-2,2′-dimethylbiphenyl (m-TB) was added to 440 grams of N,N-dimethylacetamide (DMAc). After complete dissolution, 14.866 grams of 1,2,3,4-cyclobutanetetracarboxylic dianhydride (CBDA) was added. The reaction was allowed to proceed for 3 hours under continuous stirring to form copolymer segments of m-TB and CBDA. Thereafter, 35.292 grams of 4,4′-diaminodiphenyl sulfone (44DDS) was added to the solution. After complete dissolution, 15.331 grams of 1,2,3,4-cyclobutanetetracarboxylic dianhydride (CBDA) was added. After stirring for a certain period, 24.394 grams of 3,3′,4,4′-biphenyltetracarboxylic dianhydride (BPDA) was finally added, and the temperature of the solution was maintained at 25° C. A polyamic acid solution with a solid content of 20% was obtained eventually.

### Preparation of Transparent Polyimide Film

49 grams of the polyamic acid solution and 21 grams of N,N-dimethylacetamide (DMAc) were uniformly stirred and mixed. After uniform stirring, acetic anhydride (AA) and N,N-dimethylacetamide (DMAc) were diluted at a weight ratio of 5:1, and 3-picoline (AP) and N,N-dimethylacetamide (DMAc) were diluted at a weight ratio of 1:1. Then 4.16 milliliters of the diluted AA solution and 1.66 milliliters of the diluted AP solution were added, respectively. After uniform stirring, defoaming was performed using a centrifugal defoaming machine. The defoamed solution was poured onto a glass substrate and coated using a doctor blade with a 900 μm gap. The coated sample was placed in an oven at 80° C. for baking for 20 minutes, then heated to 170° C. at a rate of 6° C./min for baking for 10 minutes, and further heated to 260° C. at a rate of 6.0° C./min for baking for 10 minutes as the final treatment.

The glass substrate was immersed in water, and the transparent polyimide film was peeled off from the glass substrate. The thickness of the transparent polyimide film was 50 μm.

### Example 3

### Production of Polyamic Acid Solution

20.117 grams of 4,4′-diamino-2,2′-dimethylbiphenyl (m-TB) was added to 440 grams of N,N-dimethylacetamide (DMAc). After complete dissolution, 16.724 grams of 1,2,3,4-cyclobutanetetracarboxylic dianhydride (CBDA) was added. The reaction was allowed to proceed for 3 hours under continuous stirring to form copolymer segments of m-TB and CBDA. Thereafter, 35.292 grams of 4,4′-diaminodiphenyl sulfone (44DDS) was added to the solution. After complete dissolution, 13.472 grams of 1,2,3,4-cyclobutanetetracarboxylic dianhydride (CBDA) was added. After stirring for a certain period, 24.394 grams of 3,3′,4,4′-biphenyltetracarboxylic dianhydride (BPDA) was finally added, and the temperature of the solution was maintained at 25° C. A polyamic acid solution with a solid content of 20% was obtained eventually.

### Preparation of Transparent Polyimide Film

49 grams of the polyamic acid solution and 21 grams of N,N-dimethylacetamide (DMAc) were uniformly stirred and mixed. After uniform stirring, acetic anhydride (AA) and N,N-dimethylacetamide (DMAc) were diluted at a weight ratio of 5:1, and 3-picoline (AP) and N,N-dimethylacetamide (DMAc) were diluted at a weight ratio of 1:1. Then 4.16 milliliters of the diluted AA solution and 1.66 milliliters of the diluted AP solution were added, respectively. After uniform stirring, defoaming was performed using a centrifugal defoaming machine. The defoamed solution was poured onto a glass substrate and coated using a doctor blade with a 900 μm gap. The coated sample was placed in an oven at 80° C. for baking for 20 minutes, then heated to 170° C. at a rate of 6° C./min for baking for 10 minutes, and further heated to 260° C. at a rate of 6.0° C./min for baking for 10 minutes as the final treatment.

The glass substrate was immersed in water, and the transparent polyimide film was peeled off from the glass substrate. The thickness of the transparent polyimide film was 50 μm.

### Example 4

### Production of Polyamic Acid Solution

20.117 grams of 4,4′-diamino-2,2′-dimethylbiphenyl (m-TB) was added to 440 grams of N,N-dimethylacetamide (DMAc). After complete dissolution, 13.008 grams of 1,2,3,4-cyclobutanetetracarboxylic dianhydride (CBDA) was added. The reaction was allowed to proceed for 3 hours under continuous stirring to form copolymer segments of m-TB and CBDA. Thereafter, 35.292 grams of 3,3′-diaminodiphenyl sulfone (33DDS) was added to the solution. After complete dissolution, 17.189 grams of 1,2,3,4-cyclobutanetetracarboxylic dianhydride (CBDA) was added. After stirring for a certain period, 24.394 grams of 3,3′,4,4′-biphenyltetracarboxylic dianhydride (BPDA) was finally added, and the temperature of the solution was maintained at 25° C. A polyamic acid solution with a solid content of 20% was obtained eventually.

### Preparation of Transparent Polyimide Film

49 grams of the polyamic acid solution and 21 grams of N,N-dimethylacetamide (DMAc) were uniformly stirred and mixed. After uniform stirring, acetic anhydride (AA) and N,N-dimethylacetamide (DMAc) were diluted at a weight ratio of 5:1, and 3-picoline (AP) and N,N-dimethylacetamide (DMAc) were diluted at a weight ratio of 1:1. Then 4.16 milliliters of the diluted AA solution and 1.66 milliliters of the diluted AP solution were added, respectively. After uniform stirring, defoaming was performed using a centrifugal defoaming machine. The defoamed solution was poured onto a glass substrate and coated using a doctor blade with a 900 μm gap. The coated sample was placed in an oven at 80° C. for baking for 20 minutes, then heated to 170° C. at a rate of 6° C./min for baking for 10 minutes, and further heated to 260° C. at a rate of 6.0° C./min for baking for 10 minutes as the final treatment.

The glass substrate was immersed in water, and the transparent polyimide film was peeled off from the glass substrate. The thickness of the transparent polyimide film was 50 μm.

### Example 5

### Production of Polyamic Acid Solution

16.249 grams of 4,4′-diamino-2,2′-dimethylbiphenyl (m-TB) was added to 440 grams of N,N-dimethylacetamide (DMAc). After complete dissolution, 10.507 grams of 1,2,3,4-cyclobutanetetracarboxylic dianhydride (CBDA) was added. The reaction was allowed to proceed for 3 hours under continuous stirring to form copolymer segments of m-TB and CBDA. Thereafter, 49.654 grams of bis[4-(3-aminophenoxy)phenyl]sulfone (m-BAPS) was added to the solution. After complete dissolution, 13.884 grams of 1,2,3,4-cyclobutanetetracarboxylic dianhydride (CBDA) was added. After stirring for a certain period, 19.705 grams of 3,3′,4,4′-biphenyltetracarboxylic dianhydride (BPDA) was finally added, and the temperature of the solution was maintained at 25° C. A polyamic acid solution with a solid content of 20% was obtained eventually.

### Preparation of Transparent Polyimide Film

49 grams of the polyamic acid solution and 21 grams of N,N-dimethylacetamide (DMAc) were uniformly stirred and mixed. After uniform stirring, acetic anhydride (AA) and N,N-dimethylacetamide (DMAc) were diluted at a weight ratio of 5:1, and 3-picoline (AP) and N,N-dimethylacetamide (DMAc) were diluted at a weight ratio of 1:1. Then 3.36 milliliters of the diluted AA solution and 1.34 milliliters of the diluted AP solution were added, respectively. After uniform stirring, defoaming was performed using a centrifugal defoaming machine. The defoamed solution was poured onto a glass substrate and coated using a doctor blade with a 900 μm gap. The coated sample was placed in an oven at 80° C. for baking for 20 minutes, then heated to 170° C. at a rate of 6° C./min for baking for 10 minutes, and further heated to 260° C. at a rate of 6.0° C./min for baking for 10 minutes as the final treatment.

The glass substrate was immersed in water, and the transparent polyimide film was peeled off from the glass substrate. The thickness of the transparent polyimide film was 50 μm.

### Example 6

### Production of Polyamic Acid Solution

21.121 grams of 4,4′-diamino-2,2′-dimethylbiphenyl (m-TB) was added to 440 grams of N,N-dimethylacetamide (DMAc). After complete dissolution, 15.608 grams of 1,2,3,4-cyclobutanetetracarboxylic dianhydride (CBDA) was added. The reaction was allowed to proceed for 3 hours under continuous stirring to form copolymer segments of m-TB and CBDA. Thereafter, 43.027 grams of bis[4-(4-aminophenoxy)phenyl]sulfone (p-BAPS) was added to the solution. After complete dissolution, 9.755 grams of 1,2,3,4-cyclobutanetetracarboxylic dianhydride (CBDA) was added. After stirring for a certain period, 20.489 grams of 3,3′,4,4′-biphenyltetracarboxylic dianhydride (BPDA) was finally added, and the temperature of the solution was maintained at 25° C. A polyamic acid solution with a solid content of 20% was obtained eventually.

### Preparation of Transparent Polyimide Film

49 grams of the polyamic acid solution and 21 grams of N,N-dimethylacetamide (DMAc) were uniformly stirred and mixed. After uniform stirring, acetic anhydride (AA) and N,N-dimethylacetamide (DMAc) were diluted at a weight ratio of 5:1, and 3-picoline (AP) and N,N-dimethylacetamide (DMAc) were diluted at a weight ratio of 1:1. Then 3.5 milliliters of the diluted AA solution and 1.39 milliliters of the diluted AP solution were added, respectively. After uniform stirring, defoaming was performed using a centrifugal defoaming machine. The defoamed solution was poured onto a glass substrate and coated using a doctor blade with a 900 μm gap. The coated sample was placed in an oven at 80° C. for baking for 20 minutes, then heated to 170° C. at a rate of 6° C./min for baking for 10 minutes, and further heated to 260° C. at a rate of 6.0° C./min for baking for 10 minutes as the final treatment.

The glass substrate was immersed in water, and the transparent polyimide film was peeled off from the glass substrate. The thickness of the transparent polyimide film was 50 μm.

### Example 7

### Production of Polyamic Acid Solution

21.004 grams of 4,4′-diamino-2,2′-dimethylbiphenyl (m-TB) was added to 440 grams of N,N-dimethylacetamide (DMAc). After complete dissolution, 36.849 grams of 4,4′-diaminodiphenyl sulfone (44DDS) was added. Upon its complete dissolution, 41.230 grams of 1,2,3,4-cyclobutanetetracarboxylic dianhydride (CBDA) was added. After stirring for a certain period, 10.916 grams of 3,3′,4,4′-biphenyltetracarboxylic dianhydride (BPDA) was finally added, and the temperature of the solution was maintained at 25° C. A polyamic acid solution with a solid content of 20% was obtained eventually.

### Preparation of Transparent Polyimide Film

49 grams of the polyamic acid solution and 21 grams of N,N-dimethylacetamide (DMAc) were uniformly stirred and mixed. After uniform stirring, acetic anhydride (AA) and N,N-dimethylacetamide (DMAc) were diluted at a weight ratio of 5:1, and 3-picoline (AP) and N,N-dimethylacetamide (DMAc) were diluted at a weight ratio of 1:1. Then 4.35 milliliters of the diluted AA solution and 1.73 milliliters of the diluted AP solution were added, respectively. After uniform stirring, defoaming was performed using a centrifugal defoaming machine. The defoamed solution was poured onto a glass substrate and coated using a doctor blade with a 900 μm gap. The coated sample was placed in an oven at 80° C. for baking for 20 minutes, then heated to 170° C. at a rate of 6° C./min for baking for 10 minutes, and further heated to 260° C. at a rate of 6.0° C./min for baking for 10 minutes as the final treatment.

The glass substrate was immersed in water, and the transparent polyimide film was peeled off from the glass substrate. The thickness of the transparent polyimide film was 50 μm.

### Example 8

### Production of Polyamic Acid Solution

27.806 grams of 4,4′-diamino-2,2′-dimethylbiphenyl (m-TB) was added to 440 grams of N,N-dimethylacetamide (DMAc). After complete dissolution, 21.681 grams of 4,4′-diaminodiphenyl sulfone (44DDS) was added. Upon its complete dissolution, 32.107 grams of 1,2,3,4-cyclobutanetetracarboxylic dianhydride (CBDA) was added. After stirring for a certain period, 28.405 grams of 4,4′-(4,4′-isopropylidenediphenoxy)diphthalic anhydride (BPADA) was finally added, and the temperature of the solution was maintained at 25° C. A polyamic acid solution with a solid content of 20% was obtained eventually.

### Preparation of Transparent Polyimide Film

49 grams of the polyamic acid solution and 21 grams of N,N-dimethylacetamide (DMAc) were uniformly stirred and mixed. After uniform stirring, acetic anhydride (AA) and N,N-dimethylacetamide (DMAc) were diluted at a weight ratio of 5:1, and 3-picoline (AP) and N,N-dimethylacetamide (DMAc) were diluted at a weight ratio of 1:1. Then 3.83 milliliters of the diluted AA solution and 1.53 milliliters of the diluted AP solution were added, respectively. After uniform stirring, defoaming was performed using a centrifugal defoaming machine. The defoamed solution was poured onto a glass substrate and coated using a doctor blade with a 900 μm gap. The coated sample was placed in an oven at 80° C. for baking for 20 minutes, then heated to 170° C. at a rate of 6° C./min for baking for 10 minutes, and further heated to 260° C. at a rate of 6.0° C./min for baking for 10 minutes as the final treatment.

The glass substrate was immersed in water, and the transparent polyimide film was peeled off from the glass substrate. The thickness of the transparent polyimide film was 50 μm.

### Example 9

### Production of Polyamic Acid Solution

20.117 grams of 4,4′-diamino-2,2′-dimethylbiphenyl (m-TB) was added to 440 grams of N,N-dimethylacetamide (DMAc). After complete dissolution, 11.150 grams of 1,2,3,4-cyclobutanetetracarboxylic dianhydride (CBDA) was added. The reaction was allowed to proceed for 3 hours under continuous stirring to form copolymer segments of m-TB and CBDA. Thereafter, 35.292 grams of 4,4′-diaminodiphenyl sulfone (44DDS) was added to the solution. After complete dissolution, 19.047 grams of 1,2,3,4-cyclobutanetetracarboxylic dianhydride (CBDA) was added. After stirring for a certain period, 24.394 grams of 3,3′,4,4′-biphenyltetracarboxylic dianhydride (BPDA) was finally added, and the temperature of the solution was maintained at 25° C. A polyamic acid solution with a solid content of 20% was obtained eventually.

### Preparation of Transparent Polyimide Film

49 grams of the polyamic acid solution and 21 grams of N,N-dimethylacetamide (DMAc) were uniformly stirred and mixed. After uniform stirring, acetic anhydride (AA) and N,N-dimethylacetamide (DMAc) were diluted at a weight ratio of 5:1, and 3-picoline (AP) and N,N-dimethylacetamide (DMAc) were diluted at a weight ratio of 1:1. Then 4.16 milliliters of the diluted AA solution and 1.66 milliliters of the diluted AP solution were added, respectively. After uniform stirring, defoaming was performed using a centrifugal defoaming machine. The defoamed solution was poured onto a glass substrate and coated using a doctor blade with a 900 μm gap. The coated sample was placed in an oven at 80° C. for baking for 20 minutes, then heated to 170° C. at a rate of 6° C./min for baking for 10 minutes, and further heated to 260° C. at a rate of 6.0° C./min for baking for 10 minutes as the final treatment.

The glass substrate was immersed in water, and the transparent polyimide film was peeled off from the glass substrate. The thickness of the transparent polyimide film was 50 μm.

### Comparative Example 1

### Preparation of Polyamic Acid Solution

15.585 grams of 4,4′-diamino-2,2′-dimethylbiphenyl (m-TB) was added to 440 grams of N,N-dimethylacetamide (DMAc). After complete dissolution, 47.622 grams of bis[4-(3-aminophenoxy)phenyl]sulfone (m-BAPS) was added. Upon its complete dissolution, 14.396 grams of 1,2,3,4-cyclobutanetetracarboxylic dianhydride (CBDA) was added. After stirring for a certain period, 32.397 grams of 3,3′,4,4′-biphenyltetracarboxylic dianhydride (BPDA) was finally added, and the temperature of the solution was maintained at 25° C. A polyamic acid solution with a solid content of 20% was obtained eventually.

### Preparation of Transparent Polyimide Film

49 grams of the polyamic acid solution and 21 grams of N,N-dimethylacetamide (DMAc) were uniformly stirred and mixed. After uniform stirring, acetic anhydride (AA) and N,N-dimethylacetamide (DMAc) were diluted at a weight ratio of 5:1, and 3-picoline (AP) and N,N-dimethylacetamide (DMAc) were diluted at a weight ratio of 1:1. Then 3.41 milliliters of the diluted AA solution and 1.22 milliliters of the diluted AP solution were added, respectively. After uniform stirring, defoaming was performed using a centrifugal defoaming machine. The defoamed solution was poured onto a glass substrate and coated using a doctor blade with a 900 μm gap. The coated sample was placed in an oven at 80° C. for baking for 20 minutes, then heated to 170° C. at a rate of 6° C./min for baking for 10 minutes, and further heated to 260° C. at a rate of 6.0° C./min for baking for 10 minutes as the final treatment.

The glass substrate was immersed in water, and the transparent polyimide film was peeled off from the glass substrate. The thickness of the transparent polyimide film was 50 μm.

### Comparative Example 2

### Preparation of Polyamic Acid Solution

7.547 grams of 4,4′-diamino-2,2′-dimethylbiphenyl (m-TB) was added to 440 grams of N,N-dimethylacetamide (DMAc). After complete dissolution, 61.495 grams of bis[4-(3-aminophenoxy)phenyl]sulfone (m-BAPS) was added. Upon its complete dissolution, 22.656 grams of 1,2,3,4-cyclobutanetetracarboxylic dianhydride (CBDA) was added. After stirring for a certain period, 18.303 grams of 3,3′,4,4′-biphenyltetracarboxylic dianhydride (BPDA) was finally added, and the temperature of the solution was maintained at 25° C. A polyamic acid solution with a solid content of 20% was obtained eventually.

### Preparation of Transparent Polyimide Film

49 grams of the polyamic acid solution and 21 grams of N,N-dimethylacetamide (DMAc) were uniformly stirred and mixed. After uniform stirring, acetic anhydride (AA) and N,N-dimethylacetamide (DMAc) were diluted at a weight ratio of 5:1, and 3-picoline (AP) and N,N-dimethylacetamide (DMAc) were diluted at a weight ratio of 1:1. Then 3.3 milliliters of the diluted AA solution and 1.18 milliliters of the diluted AP solution were added, respectively. After uniform stirring, defoaming was performed using a centrifugal defoaming machine. The defoamed solution was poured onto a glass substrate and coated using a doctor blade with a 900 μm gap. The coated sample was placed in an oven at 80° C. for baking for 20 minutes, then heated to 170° C. at a rate of 6° C./min for baking for 10 minutes, and further heated to 260° C. at a rate of 6.0° C./min for baking for 10 minutes as the final treatment.

The glass substrate was immersed in water, and the transparent polyimide film was peeled off from the glass substrate. The thickness of the transparent polyimide film was 50 μm.

The test comparison table of Examples and Comparative Examples is as follows:

| | | | | | | | | | Mole number | | |
|---|---|---|---|---|---|---|---|---|---|---|---|
| | | | | | | | | | ratio of m-TB | | Yellow |
| | | | | | | | | | to CBDA in | Young's | index |
| | Dianhydride monomer | | | | Diamine monomer | | | | the copolymer | modulus | (YI) |
| | mol % | | | | mol % | | | | segment | Gpa | — |
| Example 1 | BPDA | 35 | CBDA | 65 | m-TB | 40 | 44DDS | 60 | — | 4.4 | 4.2 |
| Example 2 | BPDA | 35 | CBDA | 65 | m-TB | 40 | 44DDS | 60 | 0.8 | 5.4 | 4 |
| Example 3 | BPDA | 35 | CBDA | 65 | m-TB | 40 | 44DDS | 60 | 0.9 | 5.7 | 4.5 |
| Example 4 | BPDA | 35 | CBDA | 65 | m-TB | 40 | 33DDS | 60 | 0.7 | 4 | 3 |
| Example 5 | BPDA | 35 | CBDA | 65 | m-TB | 40 | m-BAPS | 60 | 0.7 | 5.4 | 4.5 |
| Example 6 | BPDA | 35 | CBDA | 65 | m-TB | 50 | p-BAPS | 50 | 0.8 | 5.6 | 4.8 |
| Example 7 | BPDA | 15 | CBDA | 85 | m-TB | 40 | 44DDS | 60 | — | 5.9 | 2.5 |
| Example 8 | BPADA | 25 | CBDA | 75 | m-TB | 60 | 44DDS | 40 | — | 5.4 | 3.7 |
| Example 9 | BPDA | 35 | CBDA | 65 | m-TB | 40 | 44DDS | 60 | 0.6 | 4.8 | 4.1 |
| Comparative | BPDA | 60 | CBDA | 40 | m-TB | 40 | m-BAPS | 60 | — | 3.6 | 6.2 |
| Example 1 | | | | | | | | | | | |
| Comparative | BPDA | 35 | CBDA | 65 | m-TB | 20 | m-BAPS | 80 | — | 3.3 | 4.8 |
| Example 2 | | | | | | | | | | | |

The transparent polyimide films from Examples 1 to 9 all have a Young's modulus of 4 GPa or more and a yellow Index (YI) value of less than 5. It can be seen that the transparent polyimide films from Examples 1 to 9 have lighter colors and moderate flexibility, which are favorable for application as display cover plates.

Examples 2-3 and 5-6 show that when the mole number ratio of m-TB to CBDA in the copolymer segment is greater than 0.6, the Young's modulus of the transparent polyimide film is greater than 5 GPa.

Example 9 shows that when the mole number ratio of m-TB to CBDA in the copolymer segment is 0.6 or less, the Young's modulus of the transparent polyimide film is less than 5 GPa.

Comparative Example 1 shows that when CBDA accounts for less than 65 mol % of the total mole number of dianhydrides, the transparent polyimide film has a Young's modulus of less than 4 GPa and a yellow index (YI) greater than 5. This results in the transparent polyimide film having a darker color and softer texture, which is unfavorable for application as a display cover plate.

Comparative Example 2 shows that when m-TB accounts for less than 40 mol % of the total mole number of dianhydrides, the transparent polyimide film has a Young's modulus of less than 4 GPa. This makes the transparent polyimide film have a softer texture, which is unfavorable for application as a display cover plate.

The content of the specific examples above is provided to describe the present disclosure in detail. However, these examples are for illustrative purposes only and are not intended to limit the present disclosure. Those skilled in the art will understand that various changes or modifications made to the present disclosure, without departing from the scope defined by the appended claims, fall within a part of the present disclosure.

While the present disclosure has been described by means of specific embodiments, numerous modifications and variations could be made thereto by those skilled in the art without departing from the scope and spirit of the present disclosure set forth in the claims.

What is claimed is:

1. A transparent polyimide film obtained by polymerizing a diamine and a dianhydride to form a polyamic acid, followed by chemical cyclization, wherein the diamine comprises:
4,4′-diamino-2,2′-dimethylbiphenyl (m-TB); and
one or a combination of 3,3′-diaminodiphenyl sulfone (33DDS), 4,4′-diaminodiphenyl sulfone (44DDS), bis[4-(3-aminophenoxy)phenyl]sulfone (m-BAPS), or bis[4-(4-aminophenoxy)phenyl]sulfone (p-BAPS);
wherein based on the total mole number of the diamine, the 4,4′-diamino-2,2′-dimethylbiphenyl (m-TB) accounts for 40-60 mol %; and
the dianhydride comprises:
1,2,3,4-cyclobutanetetracarboxylic dianhydride (CBDA); and
one or a combination of 3,3′,4,4′-biphenyltetracarboxylic dianhydride (BPDA) or 4,4′-(4,4′-isopropylidenediphenoxy)diphthalic anhydride (BPADA);
wherein based on the total mole number of the dianhydride, the 1,2,3,4-cyclobutanetetracarboxylic dianhydride (CBDA) accounts for 65-85 mol %; and
wherein the transparent polyimide film has a Young's modulus of 4 GPa or more and a yellow Index (YI) value of less than 5.

2. The transparent polyimide film according to claim 1, wherein the polyamic acid comprises a copolymer segment composed of the 4,4′-diamino-2,2′-dimethylbiphenyl (m-TB) and the 1,2,3,4-cyclobutanetetracarboxylic dianhydride (CBDA).

3. The transparent polyimide film according to claim 2, wherein a mole number ratio of the 4,4′-diamino-2,2′-dimethylbiphenyl (m-TB) to the 1,2,3,4-cyclobutanetetracarboxylic dianhydride (CBDA) in the copolymer segment is greater than 0.6.

4. The transparent polyimide film according to claim 1, further comprising:
at least one color toner.

5. The transparent polyimide film according to claim 1, further comprising:
at least one ultraviolet absorber.

6. The transparent polyimide film according to claim 1, wherein a thickness of the transparent polyimide film is less than 75 μm.
